(19) United States
(12) Patent Application Publication
(10) Pub. No.: US 2008/0248232 A1
(43) Pub. Date: Oct. 9, 2008

(54) Adhesive tape roll

(75) Inventors: Ching-Mo Wu, San Chung City (TW); Hsin-Yin Wu, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 11/723,396

(22) Filed: Mar. 19, 2007

(51) Int. Cl. B32B 3/02

(52) U.S. Cl. 428/43

(57) ABSTRACT

The present invention relates to an adhesive tape roll. The adhesive tape roll is formed by connecting several adhesive plates to one another, wherein a mark portion is formed between every two adhesive plates to be recognized easily after use of the adhesive plates for facilitating tearing off of the adhesive plates so as to renew the adhesive plates.

### FIELD OF THE INVENTION

The present invention relates to an adhesive tape roll, and more particularly to a mark portion formed between every two adhesive plates for facilitating recognizing and tearing off of every adhesive plate to be suitable for use in an adhesive tape roll, a cleaning tape, a roller cleaner or the like.

### BACKGROUND OF THE INVENTION

The trash such as dust, hair, cotton wadding on the object to be cleaned such as cloth, carpet, or floor board is commonly removed by adhesion process. The adhesion process is performed by using a winding-shaped adhesive tape roll, wherein the adhesive surfaces of the adhesive tape roll are arranged to face outwardly. In addition, the adhesive tape roll can be put into a casing to form a roller-type cleaner, wherein the casing has a positioning part mounted therein for positioning the adhesive tape roll and allowing the adhesive tape roll to be freely rotatable. In addition, the casing further has a handle for being grasped by the hands of the user. During its use, there is only a need to put the roller-type cleaner on the object to be cleaned so as to adhere the trash on the object to the adhesive surface of the adhesive tape roll by shifting the adhesive tape roll forward and backward. Moreover, the winding-shaped adhesive tape roll is composed of several adhesive plates, and a separation line is formed between every two adhesive plates. As a result, if the adhesive tape roll has already been spread with trash during the cleaning process, the adhesive plate can be renewed by tearing the separation line.

However, it is very hard to recognize the separation line after the cleaning process since the surface of the adhesive plate is spread with trash. The separation line is particularly easily hidden from view if the adhesive tape roll is applied to the dustier object, causing the difficulty in renewing the adhesive plate.

In view of this, the present inventor makes diligent studies in providing general public with an adhesive tape roll that has a mark portion between every two adhesive plates near the separation line so that the separation line can be recognized and found easily to facilitate tearing off and renewing of every adhesive plate.

### SUMMARY OF THE INVENTION

It is an object of the present invention to provide an adhesive tape roll that has a mark portion between every two adhesive plates near the separation line so that the separation line can be recognized and found easily after adhering the dust to the adhesive plate to facilitate tearing off and renewing of every adhesive plate, thereby increasing overall practicability and convenience.

It is another object of the present invention to provide an adhesive tape roll that has a non-adhesive mark portion between every two adhesive plates so that the separation line can be recognized and found easily after adhering the dust to the adhesive plate to facilitate tearing off and renewing of every adhesive plate, thereby increasing overall practicability and convenience.

In order to achieve the foregoing object, an adhesive tape roll of the present invention is formed by connecting several adhesive plates to one another, wherein a mark portion is formed between every two adhesive plates to be recognized easily after use of the adhesive plates for facilitating tearing off of the adhesive plates so as to renew the adhesive plates.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is a schematic view showing that the first preferred embodiment of the present invention is coupled to a casing.

FIG. 3 is a schematic view showing the use of the first preferred embodiment of the present invention.

FIG. 4 is an elevational view showing a second preferred embodiment of the present invention.

FIG. 5 is an elevational view showing a third preferred embodiment of the present invention.

### DETAILED DESCRIPTION OF THE PREFERRED EMBODIMENT

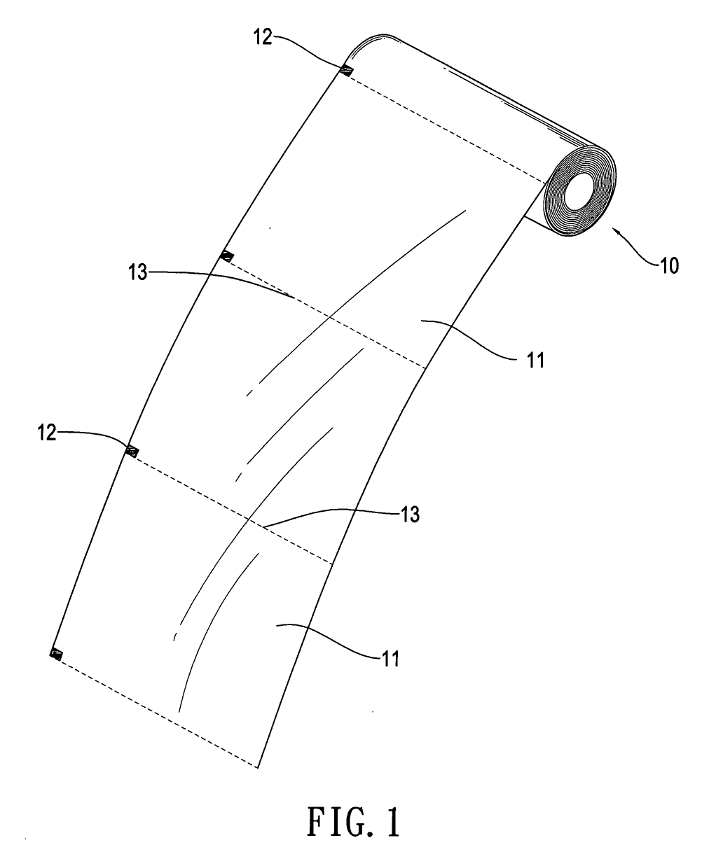

Referring to FIG. 1, an adhesive tape roll 10 of the present invention is formed by connecting several adhesive plates 11 to one another, wherein a mark portion 12 is formed between every two adhesive plates 11. The mark portion 12 may be non-adhesive. In addition, the adhesive surfaces of the adhesive plates 11 can be arranged to face outwardly. Besides, the mark portion 12 is a colored portion, and a separation line 13 is formed adjacent to the colored portion for partitioning off each of the adhesive plates 11 to facilitate tearing off and renewing of the adhesive plate 11.

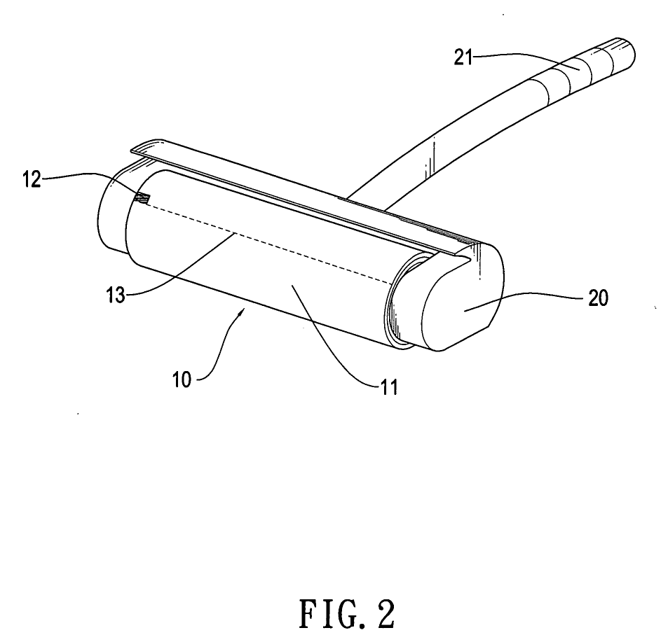

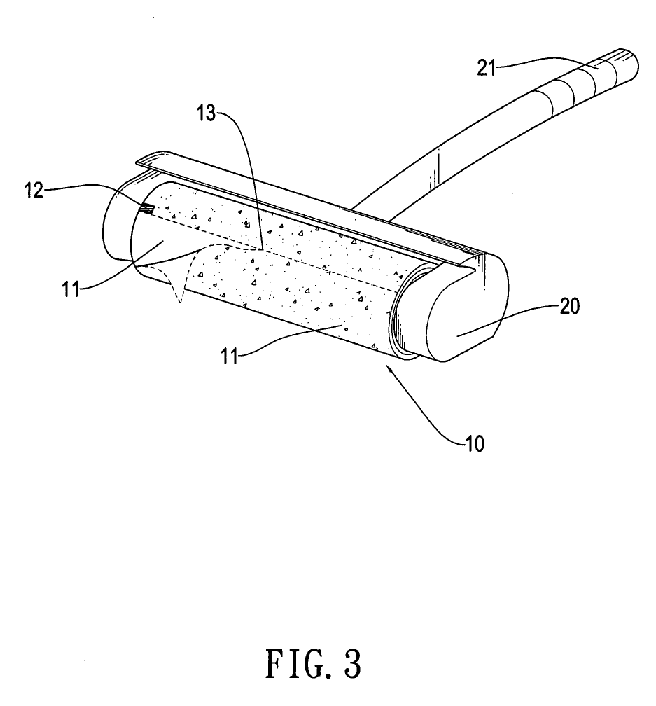

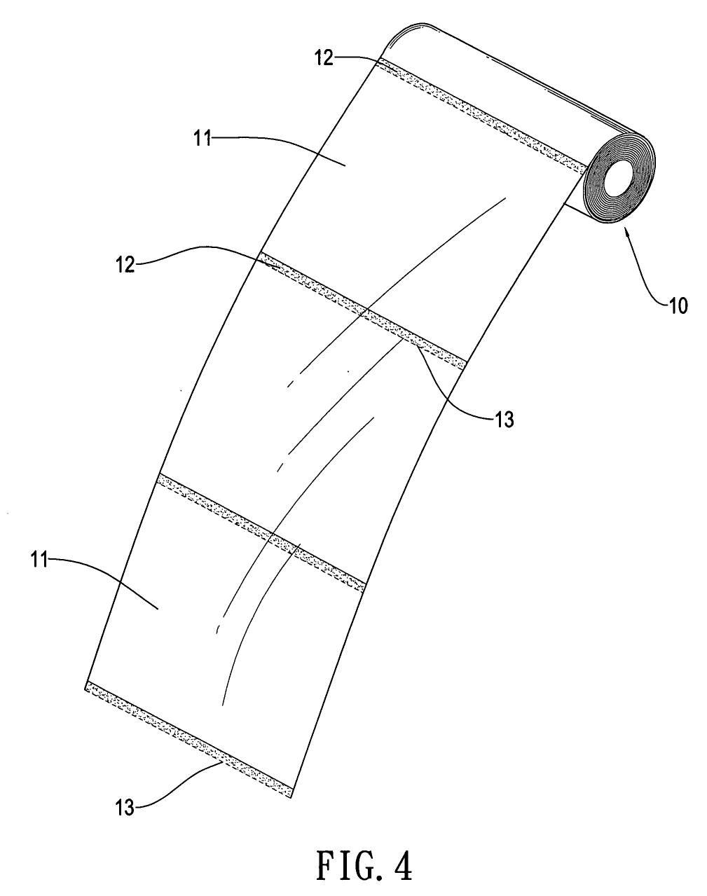

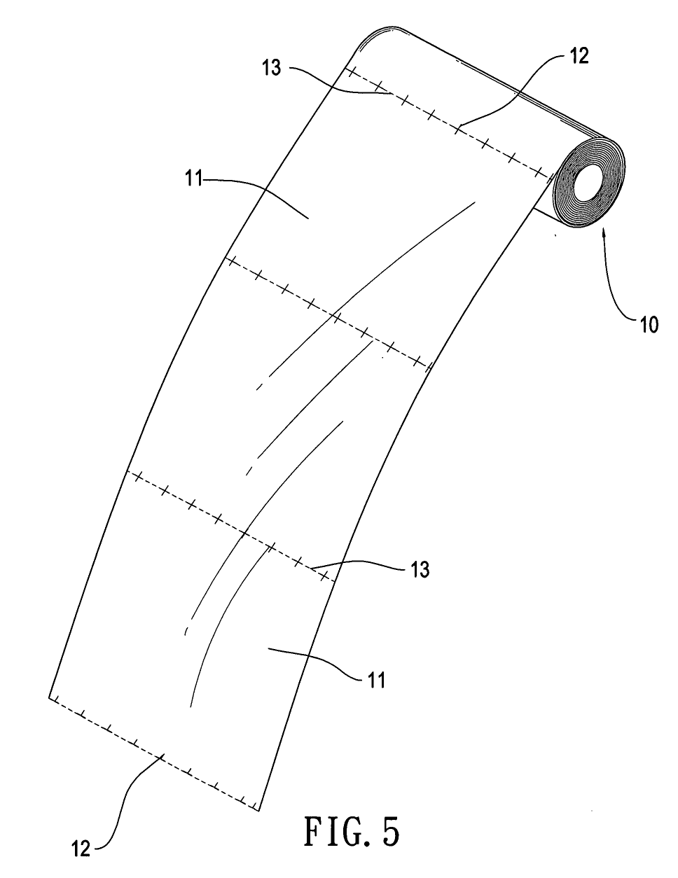

Referring to FIGS. 1 through 3, the present invention is featured in that a mark portion 12 is formed between every two adhesive plates 11 and the mark portion 12 may be a colored portion, a pattern, a letter, a sign or a character to be recognized easily even after the powdery dust had been adhered to the adhesive plates 11. Accordingly, the separation line 13 formed beside the mark portion 12 can be found easily after recognition of the mark portion 12 to facilitate tearing off and renewing of the adhesive plate 11. In addition, the mark portion 12 is so non-adhesive that only few wastes such as dust are adhered to the mark portion 12 after the cleaning process is complete. Accordingly, the mark portion 12 can be recognized easily so that the separation line 13 formed beside the mark portion 12 can be further found so as to tear off and renew the adhesive plate 11. Referring further to FIGS. 4 and 5, the mark portion 12 formed between every two adhesive plates 11 of the adhesive tape roll 10 is a bar-shaped colored portion (shown in FIG. 4) or a cross-shaped colored portion (shown in FIG. 5) so as to facilitate recognition of the position of the mark portion 12 for thereby finding the separation line 13 to renew the adhesive plate 11 easily.

Referring to FIGS. 1 through 3, in practical use, the adhesive tape roll 10 of the present invention is put into a roller-type casing 20, and positioned by a positioning part mounted in the casing 20. After being positioned in the casing 20, the adhesive tape roll 10 is freely rotatable. In addition, the casing 20 further has a handle 21 for being grasped by the user. During its use, the user only needs to grasp the handle 21 of the casing 20 to put the adhesive tape roll 10 on the object to be cleaned. As a result, the dust on the object can be adhered to the adhesive tape roll 10 by merely shifting the adhesive tape roll 10 forward and backward for completing the cleaning process. If the adhesive tape roll 10 has already been spread with trash and dust, the adhesive plate 11 can be renewed easily by recognizing the position of the mark portion 12 on the adhesive plate 11 so as to find out the separation line 13 for tearing off and renewing of the adhesive plate 11, thereby increasing practicability and convenience of use.

To sum up, the adhesive tape roll of the present invention is capable of achieving the anticipated objects described above. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An adhesive tape roll, comprising:
a plurality of adhesive plates connected to one another; and
a plurality of mark portions formed respectively between every two of said adhesive plates to be recognized easily after use of said adhesive plates for facilitating tearing off of each of said adhesive plates so as to renew said adhesive plates.

2. An adhesive tape roll according to claim 1, wherein said mark portions are non-adhesive.

3. An adhesive tape roll according to claim 1, wherein said mark portions are colored portions.

4. An adhesive tape roll according to claim 3, wherein said mark portions are non-adhesive.

5. An adhesive tape roll according to claim 1, wherein said mark portions are patterns.

6. An adhesive tape roll according to claim 5, wherein said mark portions are non-adhesive.

7. An adhesive tape roll according to claim 1, wherein said mark portions are letters.

8. An adhesive tape roll according to claim 7, wherein said mark portions are non-adhesive.

9. An adhesive tape roll according to claim 1, wherein said mark portions are signs.

10. An adhesive tape roll according to claim 9, wherein said mark portions are non-adhesive.

11. An adhesive tape roll according to claim 1, wherein said mark portions are characters.

12. An adhesive tape roll according to claim 11, wherein said mark portions are non-adhesive.

13. An adhesive tape roll according to claim 1, wherein said adhesive plates each have an outwardly faced adhesive surface respectively.
